(19) United States
(12) Patent Application Publication
(10) Pub. No.: US 2026/0299777 A1
(43) Pub. Date: Oct. 1, 2026

(54) INTELLIGENT MANAGEMENT OF LOCAL STORAGE AND REMOTE STORAGE

(71) Applicant: Telefonaktiebolaget LM Ericsson (publ), Stockholm (SE)

(72) Inventor: Dmitry KNYAGININ, Göteborg (SE)

(73) Assignee: Telefonaktiebolaget LM Ericsson (publ), Stockholm (SE)

(21) Appl. No.: 19/477,987

(22) PCT Filed: Apr. 24, 2023
(86) PCT No.: PCT/EP2023/060609

§ 371 Date: Oct. 23, 2025

(51) Int. Cl. G06F 3/06

(52) U.S. Cl. CPC G06F 3/0604; G06F 3/0655; G06F 3/067

(57) ABSTRACT

A method performed by a user equipment, UE, is provided. The method comprises determining a condition of a local storage of the UE, obtaining first condition information that indicates a condition of a data path via which the UE is connected to a remote storage, and determining how to write data to or read data from the local storage and/or the remote storage based on the condition of the local storage and the condition of the data path. The method further comprises writing data to and/or reading data from the local storage and/or the remote storage based on the determination, wherein the data path comprises a wireless network.

### TECHNICAL FIELD

This disclosure relates to intelligent management of a local storage and a remote storage of a device.

### BACKGROUND

As technology advances, the amount of data generated and/or consumed by electronic devices continuously grow. For example, many smartphones today have cameras capable of capturing 4K videos, and one hour of a 4K video may take about 45 GB of storage space. In another example, many drones today not only have multiple cameras capable of capturing high resolution videos/pictures but also have other sensors (e.g., accelerometer(s), gyroscope(s), microphone(s), etc.) generating data.

### SUMMARY

But the local storage (e.g., NAND flash disk) of a constrained device (e.g., an Internet of Things (IoT) device, a mobile phone, a tablet, a drone, etc.) has limited capacity and/or its bandwidth can be relatively low. Some devices may by design have small storage capacity and bandwidth in order to reduce the bill of materials (i.e., cost). The limited capacity and/or the low bandwidth of the local storage may limit the performance of application(s) running on the device. Also, even if the local storage of a device has high default capacity and its default bandwidth is high, as the device executes more operations, the remaining available capacity of the local storage and/or the remaining available bandwidth of the local storage may become low. As the remaining capacity and/or the remaining bandwidth become low, the performance of the device may degrade.

In order to solve the above problems, in some embodiments, a remote storage is provided to a device over a wireless network (e.g., RAN access), and the use of the remote storage and the local storage of the device is intelligently managed for maximum performance. By providing the remote storage, the total available storage capacity and the total available bandwidth for the device can be increased.

In one aspect of the embodiments of this disclosure, there is provided a method performed by a user equipment, UE. The method comprises determining a condition of a local storage of the UE, and obtaining first condition information that indicates a condition of a data path via which the UE is connected to a remote storage. The method further comprises determining how to write data to or read data from the local storage and/or the remote storage based on the condition of the local storage and the condition of the data path, and writing data to and/or reading data from the local storage and/or the remote storage based on the determination. The data path comprises a wireless network.

In another aspect, there is provided a computer program comprising instructions which when executed by processing circuitry cause the processing circuitry to perform the method of at least one of the embodiments described above.

In another aspect, there is provided a carrier containing the computer program of the above embodiment, wherein the carrier is one of an electronic signal, an optical signal, a radio signal, and a computer readable storage medium.

In another aspect, there is provided a user equipment, UE. The UE is configured to determine a condition of a local storage of the UE, and obtain first condition information that indicates a condition of a data path via which the UE is connected to a remote storage. The UE is further configured to determine how to write data to or read data from the local storage and/or the remote storage based on the condition of the local storage and the condition of the data path, and write data to and/or reading data from the local storage and/or the remote storage based on the determination, wherein the data path comprises a wireless network.

In another aspect, there is provided an apparatus. The apparatus comprises a processing circuitry; and a memory, said memory containing instructions executable by said processing circuitry, whereby the apparatus is operative to perform the method of at least one of the embodiments described above.

As discussed above, some embodiments of this disclosure allow increasing the total available storage capacity and the total available storage bandwidth for a device (e.g., a constrained device) while intelligently managing the use of a local storage and a remote storage of the device, thereby improving the performance and/or energy-efficiency of the device.

### BRIEF DESCRIPTION OF THE DRAWINGS

The accompanying drawings, which are incorporated herein and form part of the specification, illustrate various embodiments.

FIG. 1 shows a system according to some embodiments.

FIG. 2 shows an apparatus according to some embodiments.

FIG. 3 shows a process according to some embodiments.

FIG. 4 shows a system according to some embodiments.

FIG. 5(a) shows an example of how to write data to a local storage and/or a remote storage.

FIG. 5(b) shows an example of how to write data to a local storage and/or a remote storage.

FIG. 5(c) shows an example of how to write data to a local storage and/or a remote storage.

FIG. 6(a) shows an example of how to read data from a local storage and/or a remote storage.

FIG. 6(b) shows an example of how to read data from a local storage and/or a remote storage.

FIG. 6(c) shows an example of how to read data from a local storage and/or a remote storage.

FIG. 7 shows a process according to some embodiments.

FIG. 8 shows an apparatus according to some embodiments.

### DETAILED DESCRIPTION

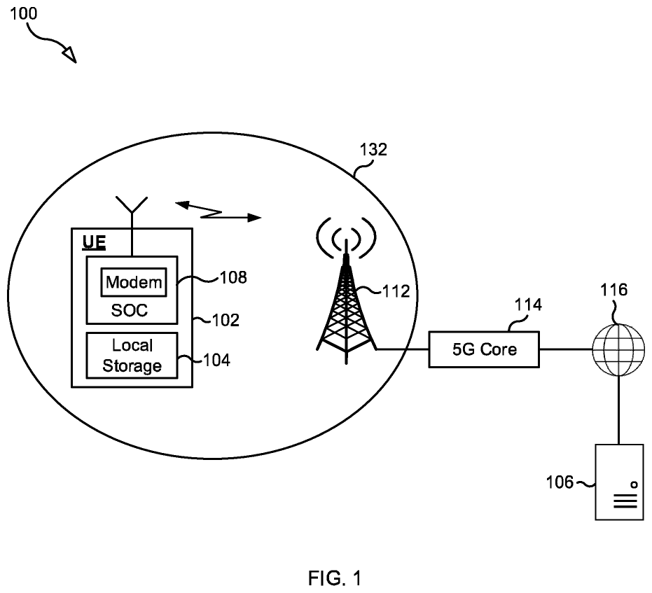

FIG. 1 shows a portion of a system 100 according to some embodiments. The system 100 comprises a user equipment (UE) 102, a network 132 provided by a base station (e.g., gNB) 112, 5G core network 114, internet 116, and a remote storage (a.k.a., “remote disk”, “remote secondary storage”) 106 for reading and writing data. The UE 102 may comprise a local storage (a.k.a., “local disk”, “local secondary storage”) 104 for reading and writing data, and a modem 108 for wirelessly communicating with the base station 112. The modem 108 may be included in a system-on-chip (SoC) or may be provided separately from the SoC. The UE 102 is configured to read data from and/or write data to the remote storage 106 by transmitting/receiving data via the base station 112, the 5G core network 114, and the internet 116. Even though FIG. 1 shows that the UE 102 is connected to the internet 116, in other embodiments, the UE 102 may be included in the base station 112 or the core network 114. Alternatively, in different embodiments, the UE 102 may be included between the base station 112 and the core network 114 or between the core network 114 and the internet 116.

The UE 102 may be any electronic device capable of reading data from and/or writing data to the local storage 104 and/or the remote storage 106. Examples of the UE 102 include an IoT device, a vehicle, a drone, a smartphone, a tablet, a laptop, a desktop, or any other computing device.

In FIG. 1, the network for communicating data between the UE 102 and the remote storage 106 is a 5G network. But in other embodiments, a different network may be used for communicating data between the UE 102 and the remote storage 106. For example, the network may be a 3G cellular network, a 4G cellular network, a Wi-Fi network, a Bluetooth network, or a Satellite network.

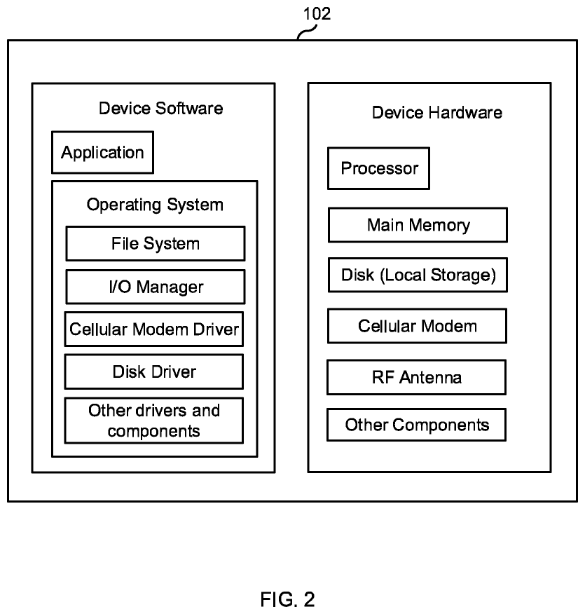

FIG. 2 shows a simplified block diagram of the UE 102, according to some embodiments. As shown in FIG. 2, the UE 102 comprises device software and device hardware. The device software may be split into application(s) and an operating system (OS), and the OS may include components such as a file system, an input/output (I/O) manager, and driver(s) for the local storage 104 and for the modem 108. The device hardware may include a processor for executing instructions of the device software, a main memory (i.e., dynamic random access memory (DRAM)), a disk (i.e., the local storage 104), the modem 108, and a radio-frequency (RF) antenna. The UE 102 is connected to the remote storage 106 via radio access network (RAN) (i.e., the wireless network 132 provided by the base station 112), the core network 114, and the external network (i.e., the Internet 116).

Applications running on the UE 102 may work with data stored or to be stored in the local storage 104 and/or the remote storage 106. For those applications, the OS of the UE 102 may control how to read data from and/or write data to the local storage 104 and/or the remote storage 106. How the OS of the UE 102 reads data from and/or writes data to the local storage 104 and/or the remote storage 106 is transparent to the applications. In other words, the applications would not know whether their relevant data are stored in the local storage 104 and/or the remote storage 106. The file system of the OS has such information.

The OS (e.g., the file system) may be configured to intelligently decide how to read data from and/or write data to the local storage 104 and/or the remote storage 106 based on the characteristics of the local storage 104, the characteristics of the remote storage 106, and characteristics of a data path between the UE 102 and the remote storage 106. These characteristics of the local storage, the remote storage, and the data path can be measured, requested, and/or predicted. The data path between the UE 102 and the remote storage 106 may comprise the network 132, the core network 114, and/or the internet 116.

These characteristics may depend on multiple factors. For example, the characteristics of the data path may be determined based on a wireless signal coverage of the network 132, signal interference (e.g., caused by the weather in the region where the base station 112 is located, foliage condition, etc.) network service-level agreements, etc. In another example, the characteristics of the local storage 104 may be determined based on a current or predicted available storage capacity, a current or predicted available bandwidth, wear out, or running low on space, etc.

According to some embodiments, depending on the characteristics of the local storage, the remote storage, and/or the data path, the OS of the UE 102 can intelligently optimize the usage of the local and remote storages. Alternatively or additionally, the usage of the local and remote storages may be optimized based on the type of application running on the UE 102 (e.g., different applications could be assigned different priorities) and/or a battery level of the UE 102. In a summary, the file system of the OS included in the UE 102 may determine how to read data from and/or write data to the local storage 104 and/or the remote storage 106 based on a condition of the UE 102 (which includes a condition of the local storage 104), a condition of the remote storage 106, and/or a condition of the data path between the UE 102 and the remote storage 106.

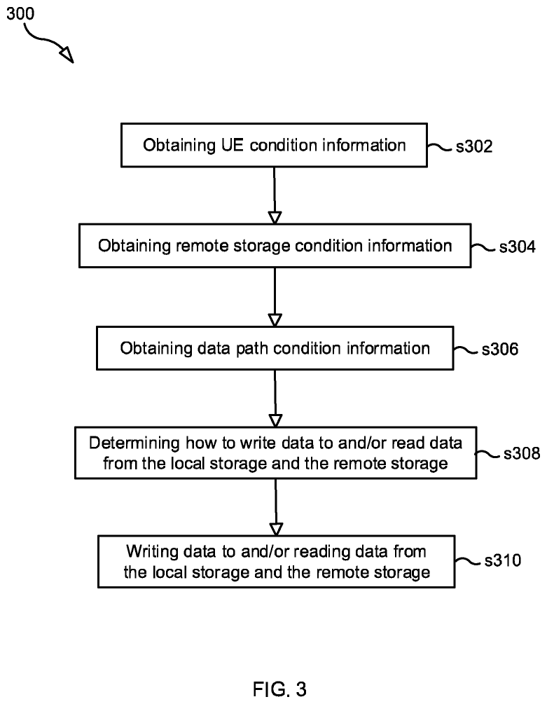

FIG. 3 shows a process 300 for intelligently determining how to read data from and/or write data to the local storage 104 and/or the remote storage 106, according to some embodiments. The process 300 may begin with step s302. The step s302 comprises obtaining UE condition information that indicates a condition of the UE 102.

### UE Condition Information

The UE condition information may indicate one or more of: a current battery level of the UE 102, application(s) that are currently running on the UE 102, fairness among the applications that are currently running on the UE 102 (e.g., UE resources (e.g., storage bandwidth) allocated to different applications), and/or a condition of the local storage 104.

The condition of the local storage 104 may indicate one or more of:
a remaining available storage space in the local storage 104,
a remaining available bandwidth (e.g., the theoretical peak bandwidth of the local storage 104 minus the currently utilized bandwidth of the local storage 104) of the local storage 104,
a load level of the local storage 104 (e.g., the number of outstanding accesses and/or outstanding access requests (which may be used to predict how much bandwidth will be utilized within a certain time window),
latency of the local storage 104 (e.g., average read access latency, average write access latency (can be tabulated for different access sizes and for different levels of load),
energy/power consumption of the local storage 104 (e.g., average amount of energy/power consumption for reading data, average amount of energy/power consumption for writing data), and
a current endurance level of the local storage 104 (e.g., a number of times NAND flash devices can be written is limited, and can be pretty low for high-density NAND flash devices).

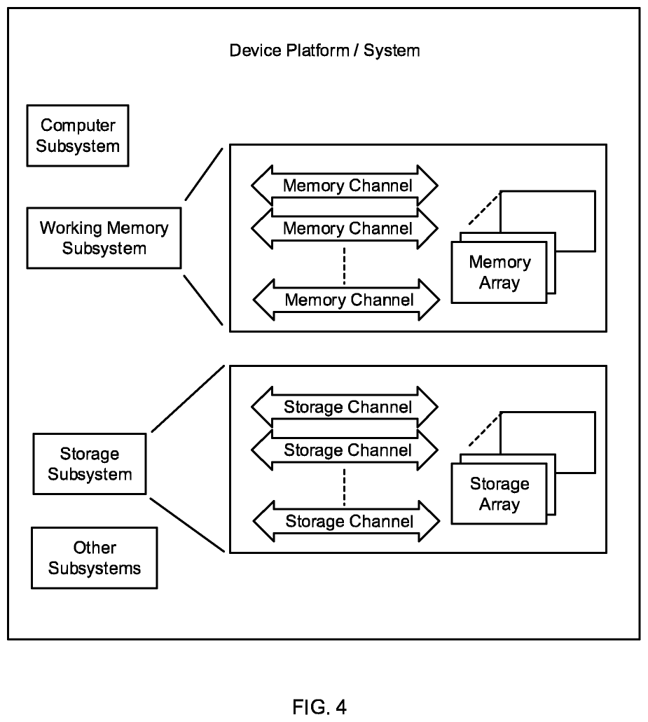

Regarding the bandwidth of the local storage 104, a total bandwidth of the local storage 104 can be expressed via a number of physical channels of the local storage 104, where each physical channel supports a certain peak bandwidth. FIG. 4 shows a device platform diagram of the UE 102. As shown in FIG. 4, the UE 102 may include a compute subsystem, working memory subsystem, and a storage subsystem. The working memory subsystem (e.g., DRAM) may be organized as a number of memory arrays accessed via a number of memory channels. Here, each channel may be connected to its own subset of memory arrays.

Depending on the memory mapping scheme, each memory request can be spread over the channels (channel-level interleaving), exposing the aggregate bandwidth of all the channels. Alternatively, each channel can serve different requests, helping to exploit the available parallelism. Likewise, the storage subsystem (e.g., NAND Flash) may be organized as a number of storage arrays accessed via a number of storage channels.

Referring back to FIG. 3, after performing the step s302, step s304 may be performed. Note that even though FIG. 3 shows that the step s304 is performed after the step s302, the step s304 may be performed before the step s302. Alternatively, the step s302 and the step s304 may be performed simultaneously. The step s304 comprises obtaining remote storage condition information.

### Remote Storage Condition Information

The remote storage condition information may indicate one or more of:
a remaining available storage space in the remote storage 106,
a remaining available bandwidth (e.g., the theoretical peak bandwidth of the remote storage 106 minus the currently utilized bandwidth of the remote storage 106) of the local storage 104,
a load level of the remote storage 106 (e.g., the number of outstanding accesses and/or outstanding access requests (which may be used to predict how much bandwidth will be utilized within a certain time window),
latency of the remote storage 106 (e.g., average read access latency, average write access latency (can be tabulated for different access sizes and for different levels of load),
energy/power consumption of the remote storage 106 (e.g., average amount of energy/power consumption for reading data, average amount of energy/power consumption for writing data (ditto)), and
a current endurance level of the remote storage 106 (e.g., a number of times NAND flash devices can be written is limited, and can be pretty low for high-density NAND flash devices).

Referring back to FIG. 3, after performing the step s304, step s306 may be performed. Note that even though FIG. 3 shows that the step s306 is performed after the steps s302 and s304, the step s306 may be performed before the steps s302 and s304. Alternatively, the steps s302, s304, and s306 may be performed simultaneously. In a summary, the steps s302, s304, and s306 may be performed in any order.

The step s306 comprises obtaining data path condition information.

### Data Path Condition Information

The data path information may indicate one or more of information about the RAN (i.e., the wireless network 132 provided by the base station 112), information about the core network 114, and information about the internet 116. Initially, the data path information may just indicate the information about the RAN, and the information about the core network 114 can be integrated into the data path information over time.

The information about the RAN may indicate one or more of an available bandwidth of the RAN, latency level of the RAN, capacity of the RAN (e.g., the maximum allowed load on the RAN), or energy/power consumption of the RAN for transmitting and/or receiving data for a UE. Similarly, the information about the core network 114 may indicate one or more of an available bandwidth of the core network, latency level of the core network, or capacity of the core network (e.g., the maximum allowed load on the core network). The information about the internet 116 may indicate how data communication is handled in the internet 116.

Note that any one or more of the indications provided in the UE condition information, the data path condition information, and/or the remote storage condition information may indicate a current state of the UE, the data path, and/or the remote storage or a predicted future state of the UE, the data path, and/or the remote storage.

For example, according to some embodiments, the information about the RAN (e.g., bandwidth, latency) may be predicted by the UE 102 or a network node included in the RAN or the core network 114 (herein after, referred as “RAN prediction”). The RAN prediction may be performed based on various inputs.

For example, the UE 102 may determine its current location using a global navigation satellite system (GNSS) receiver or some other sensor(s) and analyze a cellular signal map in view of the determined current location. Here, the cellular signal map (can be either static or dynamic) indicates which region has poor network coverage and which region has good network coverage. Then, upon determining that the UE 102 is approaching those spot(s) with poor network coverage, the UE 102 may prepare for lower performance and/or availability of accessing the remote storage 106. More specifically, in one example, upon such determination, the UE 102 may determine to write data only to the local storage 104. Alternatively, upon determining that the UE 102 is approaching those spot(s) with good network coverage, the UE 102 may prepare for higher performance and/or availability of accessing the remote storage 106. More specifically, in one example, upon such determination (and based on the condition of the remote storage 106), the UE 102 may determine to write data only to the remote storage 106 or to both the local storage 104 and the remote storage 108.

In another example, in addition to using the cellular signal map, the UE 102 may also determine the weather of a geographical region that it is approaching, and optimize the data reading/writing based on the weather condition. More specifically, in one example, in response to detecting that the UE 102 is approaching the region having bad weather (e.g., heavy rain, snow, etc.), the UE 102 may determine to write data only to the local storage 104 because the performance of the RAN is generally worse in the bad weather.

In further example, the UE 102 may receive a reference signal from the base station 112, and measure the quality of the received reference signal. Based on the measurement, the UE 102 may generate channel state information (CSI) report and/or channel quality information (CQI) report, and send the generated report to the base station 112. The UE 102 may use the generated report to determine how to write data to and/or read data from the local storage 104 and/or the remote storage 106. For example, in case the CSI indicates that the quality of the received reference signal is bad, the UE 102 may decide to write data only to the local storage 104 because the bad quality of the received reference signal indicates that the performance of the RAN is bad (which may imply low data rates and/or high Tx energy power for the UE 102).

In further example, the base station 112 may send to the UE 102 downlink control information (DCI) messages. The DCI messages may include fields such as frequency domain resource assignment, time domain resource assignment, modulation and coding scheme, power control, etc. By analyzing the DCI messages, the UE 102 may determine the condition of the data path.

In a summary, the information about the RAN may be obtained from any one or a combination of (1) the UE 102's own measurement of signals received from the base station 114, (2) the UE 102's receipt of message(s) transmitted by the base station 114, which indicate the quality of the RAN, or (3) the UE 102's prediction of the quality of the RAN that is based on one or more sensor data generated by the UE 102. In some embodiments, the UE 102 may include a statistical model or a machine learning (ML) model that is configured to determine the quality of the RAN based on any one or more of (1), (2), and (3).

Referring back to FIG. 3, after performing the steps s302, s304, and s306, the process 300 may proceed to step s308. The step s308 comprises determining how to write data to and/or read data from the local storage 104 and/or the remote storage 106 based on one or more of the UE condition information, the remote storage condition information, or the data path condition information. After performing the step s308, the process 300 may proceed to step s310. The step s310 comprises reading data from and/or writing data to the local storage 104 and/or the remote storage 106 according to the determination made in the step s308.

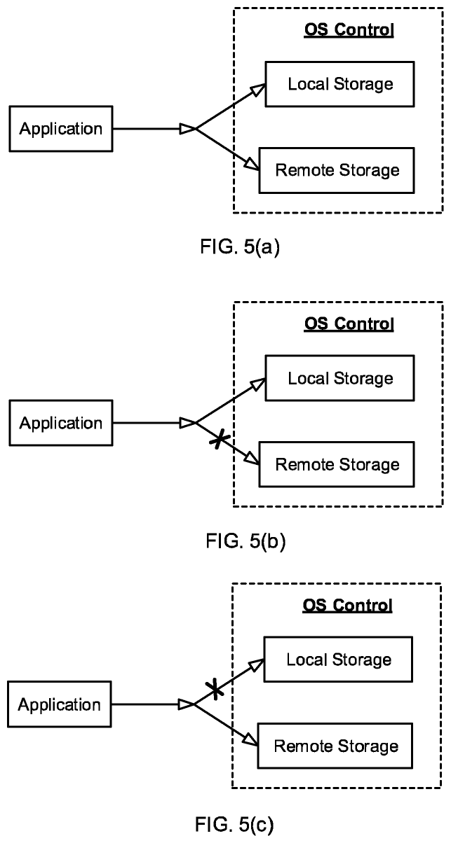

FIG. 5(a) shows an example of how to write data to the local storage 104 and/or the remote storage 106 according to some embodiments. The data may be for an application running on the UE 102, and the determination of how to write data may be performed by the OS of the UE 102. In FIG. 5(a), the data for the application is distributed across the local storage 104 and the remote storage 106. As shown in FIG. 1, the local storage 104 is included in the UE 102 while the remote storage 106 is connected to the UE 102 via the base station 112, the 5G core network 114, and the internet 116.

In some embodiments, the data written to the local storage 104 and the data written to the remote storage 106 are blocks (e.g., consecutive or non-consecutive) of the same file. By writing the blocks of the same file to the local storage 104 and the remote storage 106 in parallel, the bandwidth usage of the local storage 104 and the remote storage 106 can be maximized. Here, the locations of the blocks may be stored as metadata in the file system of the OS in the UE 102 such that the UE 102 knows how to retrieve these blocks.

FIG. 5(b) and 5(c) show other examples of how to write data to the local storage 104 and/or the remote storage 106 according to some embodiments. In FIG. 5(b), the data for the application is only written to the local storage 104 while, in FIG. 5(c), the data for the application is only written to the remote storage 106.

As explained above, in determining how to write data to the local storage 104 and/or the remote storage 106, one or more of the UE condition information, the remote storage condition information, or the data path condition information may be considered. For example, the OS of the UE 102 may decide to optimize performance for some metric(s) (e.g., latency, bandwidth, energy, lifetime (a.k.a., longevity) (expressed via local-storage endurance), fairness, utility) and decide how to write data to the local storage 104 and/or the remote storage 106 for the optimization.

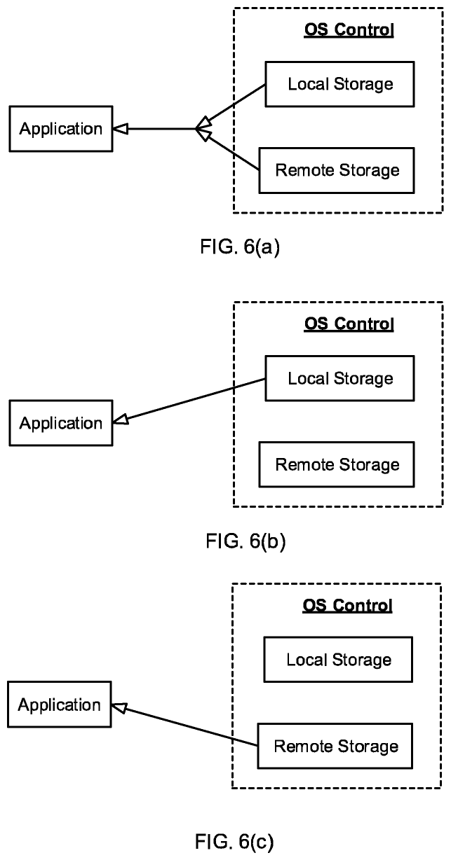

FIG. 6(a) shows an example of how to read data from the local storage 104 and/or the remote storage 106 according to some embodiments. The data may be for an application running on the UE 102, and the determination of how to read data may be performed by the OS of the UE 102. In FIG. 6(a), the data for the application is distributed across the local storage 104 and the remote storage 106, and thus the OS of the UE 102 may retrieve data from both the local storage 104 and the remote storage 106.

On the contrary, in FIG. 6(b), the data for the application is only stored in the local storage 104, and thus the OS of the UE 102 retrieves the data only from the local storage 104. Similarly, in FIG. 6(c), the data for the application is only stored in the remote storage 106, and thus the OS of the UE 102 retrieves the data only from the remote storage 106.

Writing data to and/or reading data from the local storage 104 and/or the remote storage 106 may be triggered in response to an explicit write or read request triggered by an application running on the UE 102. However, in some embodiments, the writing and/or reading may be triggered without such explicit write or read request. For example, the OS of the UE 102 may decide to optimize storage by moving (i.e., copying in advance) frequently (e.g., a number of access times within a given time interval is greater than or equal to a predefined value) accessed blocks from the remote storage 106 to the local storage 104. In another example, such optimization may be performed by predicting which data will be accessed soon, and moving such predicted data from the remote storage 106 to the local storage 104. This operation is called “prefetching,” and any known prefetching technique can be used here. Additionally or alternatively, the OS of the UE 102 may decide to optimize storage by moving rarely (e.g., a number of access times within a given time interval is less than a predefined value (e.g., a threshold value)) accessed blocks from the local storage 104 to the remote storage 106.

According to some embodiments, how to write data to and/or read data from the local storage 104 and/or the remote storage 106 may be adjusted based on one or more of the UE condition information, the data path condition information and the remote storage condition information. The following scenarios provide examples of how the writing and/or reading is adjusted.

### Scenario 1

In scenario 1, the UE condition information indicates that the remaining storage capacity of the local storage 104 is less than a threshold amount (or is equal to zero) (indicating that the local storage is almost full) while the remote storage condition information indicates that the remaining storage capacity of the remote storage 106 is greater than or equal to a threshold amount.

Upon obtaining such UE condition information and such remote storage condition information, the UE 102 may start to write data only to the remote storage 106 but not to the local storage 104. In some embodiments, the UE 102 may decide to write data only to the remote storage 106 without obtaining the remote storage condition information. The rationale here is that the UE 102 may assume that there will always be available space in the remote storage 106, and thus the UE 102 only need to consider the remaining storage capacity of the local storage 104 for the determination.

### Scenario 2

In scenario 2, the UE condition information indicates that the remaining storage capacity of the local storage 104 is greater than or equal to a threshold amount, and the remote storage condition information indicates that the remaining storage capacity of the remote storage 106 is greater than or equal to a threshold amount. But the UE condition information also indicates that the available bandwidth of the local storage 104 is less than a threshold amount (e.g., a required/desired bandwidth amount) while the remote storage condition information indicates that the available bandwidth of the remote storage 106 is greater than or equal to a threshold amount (e.g., a required/desired bandwidth amount).

In this scenario, instead of writing data only to the local storage 104, the UE 102 may write data to (i) both the local storage 104 and the remote storage 106 in parallel or (ii) only to the remote storage 106. By writing data to both the local storage 104 and the remote storage 106, the bandwidth for writing data can be increased (the combined bandwidth of the local storage 104 and the remote storage 106>the bandwidth of the local storage 104), and thus the time required for writing data can be reduced. By redistributing at least a portion of the data to be written to the local storage 104 to the remote storage 106, the time it takes to write the data to a storage can be reduced. In some embodiments, the UE 102 may decide to write data to both the local storage 104 and the remote storage 106 without obtaining the remote storage condition information. The rationale here is that the UE 102 may assume that there will always be available storage capacity and available bandwidth in the remote storage 106, and thus the UE 102 only needs to consider the remaining available storage capacity and the remaining available bandwidth of the local storage 104 for the determination.

### Scenario 3

In scenario 3, the UE condition information indicates that the remaining storage capacity of the local storage 104 is greater than or equal to a threshold amount, and the available bandwidth of the local storage 104 is less than a threshold amount (e.g., a required/desired bandwidth amount) while the remote storage condition information indicates that the remaining storage capacity of the remote storage 106 is greater than or equal to a threshold amount and the available bandwidth of the remote storage 106 is greater than or equal to a threshold amount.

But the data path information indicates that the available bandwidth of the data path is less than a threshold amount. In this scenario, even though the available bandwidth of the local storage 104 is less than a threshold amount and the available bandwidth of the remote storage 106 is greater than a threshold amount, the UE 102 may decide to write data only to the local storage 104 because of the limited available bandwidth of the data path.

As discussed above, the bandwidth of the data path may be determined by the bandwidth of the wireless network 132 provided by the base station 112 (i.e., the bandwidth of the RAN) and/or bandwidth of the 5G core network 114. More specifically, in some embodiments, the available bandwidth of the data path may be determined based on the smaller one of the bandwidth of the RAN and the bandwidth of the core network 114. For example, if the available bandwidth of the wireless network is 20 Gbps while the available bandwidth of the core network 114 is 40 Gbps, then the available bandwidth of the data path is limited to 20 Gbps.

As discussed above, even though FIG. 1 shows that the remote storage 106 is connected to the internet 116, in some embodiments, the remote storage 106 is included in the base station 112 or is connected between the base station 112 and the core network 114. In such embodiments, the bandwidth of the data path may be determined by the bandwidth of the RAN. Alternatively, in different embodiments, the remote storage 106 is included in the core network 114 or is included between the core network 114 and the internet 116. In such embodiments, the bandwidth of the data path may be determined based on the bandwidth of the RAN and the bandwidth of the core network 114.

Thus, if any one of the bandwidth of the RAN and the bandwidth of the core network is less than a threshold amount, the bandwidth of the data path is less than a threshold amount. In this scenario, even though the bandwidth of the remote storage 106 is greater than or equal a threshold, the UE 102 may decide to write data only to the local storage 104. Alternatively, the UE 102 may decide to split the data to be written into a first portion and a second portion, and write the first portion of the data to the local storage 104 and the second portion of the data to the remote storage 106. In some embodiments, the ratio of the first portion and the second portion may be determined based on the bandwidth of the local storage 104 and the bandwidth of the data path. Note that, even in the scenario where the available bandwidth of the local storage 104 is less than a threshold amount, if the remote storage 106 is unavailable (e.g., network issue), the UE 102 may continue to write data only to the local storage 104.

Instead of or in addition to determining how to write data to and/or read data from the local storage 104 and/or the remote storage 106 based on the above simple conditions (e.g., whether the remaining storage capacity of the local storage 104 is full, whether the remaining bandwidth of the local storage 104 is less than a required bandwidth, etc.), in some embodiments, the UE 102 may make the determination based on one or more storage usage policies (herein after, just “policies”). The policies may account for the following factors:
Wear of the local storage 104: Prioritize storing data to the remote storage 106;
Limited capacity of the local storage 104: Prioritize storing data to the remote storage 106;
Security: Prioritize interleaving—Writing a portion of data to the local storage 104 and a portion of the data to the remote storage 106;
Cost for using the network: Prioritize storing data to the local storage 104;
Aggregate bandwidth: Prioritize using both the local storage 104 and the remote storage 106 in parallel; and
Bandwidth per power (watt): Prioritize a storage that offers higher power efficiency and/or energy efficiency.

Under the “aggregate bandwidth” policy, the UE 102 may utilize both the local and remote storages 104 and 106 in a balanced way based on the actual (runtime) bandwidth. For instance, if the remote storage 106 can write 3 blocks during a time interval while the local storage 104 can write 1 block during the same time interval, under the policy, the UE 102 may determine to write 3 blocks for each 4 blocks schedule to the remote storage 106 and 1 block for each 4 blocks schedule to the local storage 104.

Note that this policy disregards energy/power required to provide a bandwidth boost, which can be beneficial when the pressure on the storage subsystem is high (where “high” can mean that none of the channels can meet the bandwidth demand by itself). Also the decision made under this policy may be limited by thermal budget of the UE 102. For example, in the above scenario, even if the local storage 104 can write 1 block during the same time interval, if such writing causes the temperature of the UE 102 to increase beyond a safe threshold, the UE 102 may decide to write all data to the remote storage 106. Likewise, the other way around, if writing to the remote storage risks increasing the temperature beyond a safe threshold, the OS may decide to write all data to 104.

In the “bandwidth per power” policy, the UE 102 may compare how much data the UE 102 can write to the local storage 104 during a set time interval using a set amount of power and how much data the UE 102 can write to the remote storage 106 during the set time interval using the set amount of power. Based on the comparison, the UE 102 may determine how to write data to the local storage 104 and/or the remote storage 106.

For example, let's assume that the UE 102 can write 20 Gb data to any of the local storage 104 and the remote storage 106 per second. But the UE 102 needs to spend 1 watt of power to write at 20 Gbps of data to the local storage 104 while it needs to spend 4 watts of power to write a 20 Gbps of data to the remote storage 106. In this example, the UE 102 may determine to write data only to the local storage 104 (or to both the local storage 104 and the remote storage 106).

In some embodiments, the UE 102 may compare the amount of data that the UE 102 can write to the local storage 104 using a preset amount of power during a predefined time interval and the amount of data that the UE 102 can write to the remote storage 106 using the preset amount of power during the predefined time interval. If the difference between them is less than a threshold value, the UE 102 may determine to perform interleaving—i.e., writing data both to the local storage 104 and the remote storage 106. On the other hand, if the difference is significant, the UE 102 may determine to write data only to the storage that allows to write more data using the same amount of power (and/or energy).

The “aggregate bandwidth” and “bandwidth per power” policies may be used dynamically. For instance, when the pressure on the storage subsystem is high, the former policy can be used, otherwise the latter policy can be used. The rationale here is that when the pressure on the storage subsystem is high, power/energy consumption may be less important.

### Scenario 4

Scenario 4 is an exemplary scenario where whether to write data to the local storage 104 and/or the remote storage 106 is determined not only by the remaining storage and bandwidth of the local and remote storages but also by how much power and/or energy the UE 102 needs to consume to write data to the local storage 104 and/or the remote storage 106. More specifically, in the scenario 4, the UE condition information indicates that the remaining storage capacity of the local storage 104 is greater than or equal to a threshold amount (meaning that data can be written to the local storage 104), and the remote storage condition information indicates that the remaining storage capacity of the remote storage 106 is greater than or equal to a threshold amount (meaning that data can be written to the remote storage 106). Here, the threshold amount for the local storage 104 may be same as or different from the threshold amount for the remote storage 106. The UE condition information also indicates that available power budget for writing a chunk S of data (i.e., the amount of power the UE 102 is allowed to use for writing the chunk S of data) is P_{UE-Writing-Budget}.

In case the amount of power that the UE 102 needs to consume to write the chunk S of data to the local storage 104 (i.e., P_{UE-Writing-Local}) is less than P_{UE-Writing-Budget} while the amount of power that the UE 102 needs to consume to write the chunk S of data to the remote storage 106 (i.e., P_{UE-Writing-Remote}) is greater than P_{UE-Writing-Budget}, then the UE 102 may write the chunk S of data just to the local storage 104. On the other hand, in case P_{UE-Writing-Remote} is less than P_{UE-Writing-Budget} while P_{UE-Writing-Local} is greater than P_{UE-Writing-Budget}, then the UE 102 may write the chunk S of data just to the remote storage 106. One example of the units of P_{UE-Writing-Budget}, P_{UE-Writing-Remote}, and P_{UE-Writing-Local} is watt.

In case both of P_{UE-Writing-Local} and P_{UE-Writing-Remote} is less than P_{UE-Writing-Budget}, the UE 102 may decide whether to write the chunk S of data only to the local storage 104 or the remote storage 106, or write the chunk S of data to both of the local storage 104 and the remote storage 106.

In some embodiments, the UE 102 may decide to write the chunk S of data as quickly as possible regardless of how much power the UE 102 consumes in writing such the chunk S of data as long as the total power consumption is less than P_{UE-Writing-Budget}. In such scenario, if a combination of P_{UE-Writing-Local} and P_{UE-Writing-Remote} is less than P_{UE-Writing-Budget}, the UE 102 may determine to write the chunk S of data to both the local storage 104 and the remote storage 106. On the other hand, if the combination of P_{UE-Writing-Local} and P_{UE-Writing-Remote} is greater than P_{UE-Writing-Budget}, but any one of P_{UE-Writing-Local} and P_{UE-Writing-Remote} is less than P_{UE-Writing-Budget}, the UE 102 may decide to write the chunk S of data only to the storage which offers the higher bandwidth. For example, the UE 102 may decide to write the chunk S of data only to the local storage 104 if the local storage 104 offers a higher bandwidth for writing while the UE 102 may decide to write the chunk S of data only to the remote storage 106 if the remote storage 106 offsers a higher bandwidth for writing.

In other embodiments, the UE 102 may decide to write the chunk S of data with the minimum power/energy usage. In such embodiments, the UE 102 may calculate how long it would take for the UE 102 to write the chunk S of data to each of the local storage 104 and/or the remote storage 106, and calculate the total amount of energy it would consume for writing the chunk S of data to each of the local storage 104 and/or the remote storage 106. For example, assume that the available bandwidth for writing the chunk S of data to the local storage device 104 is B_{UE-Writing-Local} while the available bandwidth for writing the chunk S of data to the remote storage device 106 is B_{UE-Writing-Remote} One example of the units of B_{UE-Writing-Local} and B_{UE-Writing-Remote} is Mbps.

One way to calculate how long it would take for the UE 102 to write the chunk S of data to each of the local storage 104 and/or the remote storage 106 is calculating Dₐₘₒᵤₙₜ/B_{UE-Writing-Local} and/or Dₐₘₒᵤₙₜ/B_{UE-Writing-Remote}, where Dₐₘₒᵤₙₜ is the amount of the chunk S of data. For example, if Dₐₘₒᵤₙₜ is 1000 Mbps and B_{UE-Writing-Local} is 100 Mbps, it would take 10 seconds for the UE 102 to write the chunk S of data to the local storage 104. After calculating how long it would take for the UE 102 to write data to each of the local storage 104 (T_{UE-Writing-Local})) and/or the remote storage 106 (T_{UE-Writing-Remote})), the UE 102 may calculate the total amount of energy the UE 102 needs to consume to write the chunk S of data to the local storage 104 and/or the remote storage 106.

For example, the UE 102 may calculate the total amount of energy the UE 102 needs to spend to write the chunk S of data to the local storage 104 (E_{UE-Writing-Local}) and/or the remote storage 106 (E_{UE-Writing-Remote}) as follows: E_{UE-Writing-Local}=T_{UE-Writing-Local}×P_{UE-Writing-Local} and E_{UE-Writing-Remote}=T_{UE-Writing-Remote}×P_{UE-Writing-Remote}. Then the UE 102 may compare E_{UE-Writing-Remote} and E_{UE-Writing-Local} with each other, and may choose the one that consumes less power/energy for writing the chunk S of data. More specifically, in case E_{UE-Writing-Remote}>E_{UE-Writing-Local}, the UE 102 may decide to write the chunk S of data only to the local storage 104 since the UE 102 can spend less energy to write the chunk S of data to the local storage 104. Even in the scenario where E_{UE-Writing-Remote}>E_{UE-Writing-Local}, the UE 102 may write data only to the remote storage 106 if the difference between E_{UE-Writing-Remote} and E_{UE-Writing-Local} is not significant (e.g., less than a preset amount) or if the use of the remote storage 106 is prioritized by some other criterion.

In the scenario 4, determining whether to write data to the local storage 104 and/or the remote storage 106 can be determined for each chunk S of data or for a large number of chunks of data. In some embodiments, B_{UE-Writing-Remote} is determined by the available bandwidth of the RAN network 132 provided by the base station 112, the core network 114, and the internet 116. But, in other embodiments, B_{UE-Writing-Remote} may be determined by any one or a combination of the available bandwidth of the RAN network 132 provided by the base station 112, the core network 114, and the internet 116.

### Benefits

The intelligent storage management according to some embodiments of this disclosure may provide any one or more of the following benefits:

First, the intelligent storage management can render the storage capacity of the UE 102 unlimited by utilizing the remote storage 106.

Second, the intelligent storage management can prolong the wear of the local storage 104 by using the local storage 104 less and using the remote storage 106 more. Note that the local storage 104 has limited endurance (e.g., a limited number of writings permitted due to limitations of the storage technology).

Third, the intelligent storage management can boost a total available storage bandwidth by combining the bandwidth of the local storage 104 and the bandwidth of the remote storage 106.

Fourth, the intelligent storage management can improve the efficiency of storing operations by prioritizing to store in one of the local storage 104 and the remote storage 106, which provides a higher bandwidth per energy (e.g., joule) or power.

Fifth, the intelligent storage management can improve the security of data. In case data of a file is distributed across the local storage 104 and the remote storage 106, no file will get transferred over the radio link in its entirety, and thus an attacker cannot intercept the entire file.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

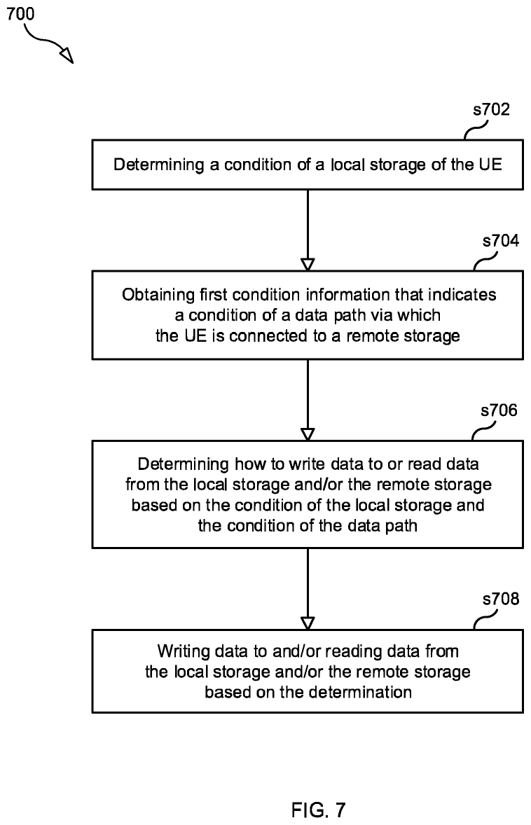

FIG. 7 shows a process 700 performed by the UE 102 according to some embodiments. The process 700 may begin with step s702. The step s702 comprises determining a condition of a local storage of the UE. Step s704 comprises obtaining first condition information that indicates a condition of a data path via which the UE is connected to a remote storage. Step s706 comprises determining how to write data to or read data from the local storage and/or the remote storage based on the condition of the local storage and the condition of the data path. Step s708 comprises writing data to and/or reading data from the local storage and/or the remote storage based on the determination. The data path comprises a wireless network.

In some embodiments, the condition of the local storage is determined based on one or more of: an amount of a storage capacity of the local storage, which is currently available or is predicted to be available during a certain time interval; an amount of bandwidth which is currently available or is predicted to be available for writing data to and/or reading data from the local storage; an estimated or predicted latency of writing data to and/or reading data from the local storage; an amount of energy required, used, or predicted to be used for writing data and/or reading data from the local storage; and/or a remaining lifetime of the local storage.

In some embodiments, the local storage comprises one or more local storage devices accessible via one or more storage channels, and the amount of peak bandwidth for writing data to and/or reading data from the local storage corresponds to a number of available storage channels in said one or more storage channels.

In some embodiments, the wireless network is a cellular network provided by one or more base stations, and obtaining the first condition information comprises receiving from said one or more base stations one or more messages includes the first condition information.

In some embodiments, the first condition information comprises one or more of: information about frequency domain resources assigned to the UE, information about time domain resources assigned to the UE, a modulation and coding scheme to be used for communications between the UE and the base station and information about the UE's usage of power for communicating with the base station.

In some embodiments, the wireless network is a cellular network provided by a base station, obtaining the first condition information comprises: determining a location of the UE; and based on the determined location of the UE, determining a condition of the cellular network, and the condition of the cellular network is a current condition of the cellular network or a predicted condition of the cellular network.

In some embodiments, the process 700 comprises obtaining second condition information that indicates a condition of the remote storage, wherein the condition of the remote storage is determined based on one or more of: an amount of a storage capacity of the remote storage, which is currently available or is predicted to be available during a certain time interval; an amount of bandwidth which is currently available or is predicted to be available for writing data to and/or reading data from the remote storage; and/or an estimated or predicted latency of writing data to and/or reading data from the local storage.

In some embodiments, the wireless network is a satellite communication network or a Wi-Fi network, and the first condition information indicates a signal strength of the satellite communication network or the Wi-Fi network.

In some embodiments, writing data to and/or reading data from the local storage and/or the remote storage comprises writing a first portion of data of a file to the local storage and a second portion of the data of the same file to the remote storage.

In some embodiments, writing data to and/or reading data from the local storage and/or the remote storage comprises: determining a pattern of accessing certain data stored in the remote storage; based on the determined pattern, reading said certain data from the remote storage and writing said certain data to the local storage.

In some embodiments, writing data to and/or reading data from the local storage and/or the remote storage comprises: determining a pattern of accessing certain data stored in the local storage; based on the determined pattern, reading said certain data from the local storage and writing said certain data to the remote storage.

In some embodiments, the process 700 comprises receiving an instruction to read certain data stored in the remote storage, in response to receiving the instruction, reading said certain data from the remote storage and writing said certain data to the local storage.

In some embodiments, the process 700 comprises making a comparison based on the amount of bandwidth which is currently available or is predicted to be available for writing data to and/or reading data from the local storage and the amount of bandwidth which is currently available or is predicted to be available for writing data to and/or reading data from the remote storage, wherein how to write data to or read data from the local storage and/or the remote storage is determined based on the comparison.

In some embodiments, making the comparison comprises comparing the amount of bandwidth which is currently available or is predicted to be available for writing data to and/or reading data from the local storage to the amount of bandwidth which is currently available or is predicted to be available for writing data to and/or reading data from the remote storage. The process 700 comprises determining a ratio value based on the comparison; and writing a first portion of data to the local storage and a second portion of the data to the remote storage. Each of the first portion and the second portion is determined based on the ratio value.

In some embodiments, the amount of bandwidth which is currently available or is predicted to be available for writing data to and/or reading data from the local storage is a first amount of bandwidth, the amount of bandwidth which is currently available or is predicted to be available for writing data to and/or reading data from the remote storage is a second amount of bandwidth, and making the comparison comprises comparing the first amount of bandwidth per power/energy to the second amount of bandwidth per power/energy.

In some embodiments, in case the difference between the first amount of bandwidth per energy and the second amount of bandwidth per power/energy is less than a threshold value, writing a first portion of data to the local storage and a second portion of the data to the remote storage.

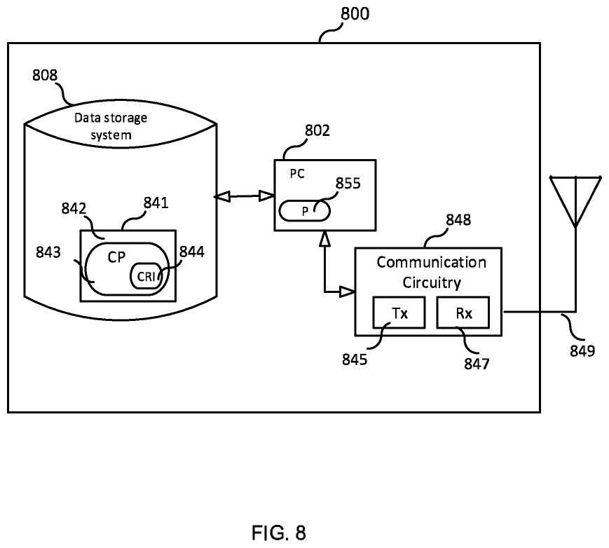

FIG. 8 is a block diagram of UE 102, according to some embodiments. As shown in FIG. 8, UE 102 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like); communication circuitry (e.g., a modem) 848, which is coupled to an antenna arrangement 849 comprising one or more antennas and which comprises a transmitter (Tx) 845 and a receiver (Rx) 847 for enabling UE 102 to transmit data and receive data (e.g., wirelessly transmit/receive data); and a local storage unit (a.k.a., “data storage system”) 808, which may include one or more non-volatile storage devices and/or one or more volatile storage devices. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes UE 102 to perform steps described herein (e.g., steps described herein with reference to the flow charts). In other embodiments, UE 102 may be configured to perform steps described herein without the need for code. That is, for example, PC 802 may consist merely of one or more ASICs. Hence, the features of the embodiments described herein may be implemented in hardware and/or software.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.” Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a user equipment, UE, the method comprising:
determining a condition of a local storage of the UE;
obtaining first condition information that indicates a condition of a data path via which the UE is connected to a remote storage;
determining how to write data to or read data from the local storage and/or the remote storage based on the condition of the local storage and the condition of the data path; and
writing data to and/or reading data from the local storage and/or the remote storage based on the determination, wherein
the data path comprises a wireless network.

2. The method of claim 1, wherein
the condition of the local storage is determined based on:
an amount of a storage capacity of the local storage, which is currently available or is predicted to be available during a certain time interval;
an amount of bandwidth which is currently available or is predicted to be available for writing data to and/or reading data from the local storage;
an estimated or predicted latency of writing data to and/or reading data from the local storage;
an amount of energy required, used, or predicted to be used for writing data and/or reading data from the local storage; and/or
a remaining lifetime of the local storage.

3. The method of claim 2, wherein
the local storage comprises one or more local storage devices accessible via one or more storage channels, and
the amount of peak bandwidth for writing data to and/or reading data from the local storage corresponds to a number of available storage channels in said one or more storage channels.

4. The method of claim 1, wherein
the wireless network is a cellular network provided by one or more base stations, and
obtaining the first condition information comprises receiving from said one or more base stations one or more messages includes the first condition information.

5. The method of claim 4, wherein
the first condition information comprises one or more of: information about frequency domain resources assigned to the UE, information about time domain resources assigned to the UE, and/or a modulation and coding scheme to be used for communications between the UE and the base station and information about the UE's usage of power for communicating with the base station.

6. The method of claim 1, wherein
the wireless network is a cellular network provided by a base station,
obtaining the first condition information comprises:
determining a location of the UE; and
based on the determined location of the UE, determining a condition of the cellular network, and
the condition of the cellular network is a current condition of the cellular network or a predicted condition of the cellular network.

7. The method of claim 1, wherein
the method further comprises:
obtaining second condition information that indicates a condition of the remote storage, wherein the condition of the remote storage is determined based on one or more of:
an amount of a storage capacity of the remote storage, which is currently available or is predicted to be available during a certain time interval,
an amount of bandwidth which is currently available or is predicted to be available for writing data to and/or reading data from the remote storage, and/or
an estimated or predicted latency of writing data to and/or reading data from the local storage.

8. The method of claim 1, wherein
the wireless network is a satellite communication network or a Wi-Fi network, and
the first condition information indicates a signal strength of the satellite communication network or the Wi-Fi network.

9. The method of claim 1, wherein
writing data to and/or reading data from the local storage and/or the remote storage comprises:
writing a first portion of data of a file to the local storage and a second portion of the data of the same file to the remote storage.

10. The method of claim 1, wherein
writing data to and/or reading data from the local storage and/or the remote storage comprises:
determining a pattern of accessing certain data stored in the remote storage; and
based on the determined pattern, reading said certain data from the remote storage and writing said certain data to the local storage.

11. The method of claim 1, wherein
writing data to and/or reading data from the local storage and/or the remote storage comprises:
determining a pattern of accessing certain data stored in the local storage; and
based on the determined pattern, reading said certain data from the local storage and writing said certain data to the remote storage.

12. The method of claim 1, wherein
the method further comprises:
receiving an instruction to read certain data stored in the remote storage; and
in response to receiving the instruction, reading said certain data from the remote storage and writing said certain data to the local storage.

13. The method of claim 7, wherein
the condition of the local storage is determined based on:
an amount of a storage capacity of the local storage, which is currently available or is predicted to be available during a certain time interval;
an amount of bandwidth which is currently available or is predicted to be available for writing data to and/or reading data from the local storage;
an estimated or predicted latency of writing data to and/or reading data from the local storage;
an amount of energy required, used, or predicted to be used for writing data and/or reading data from the local storage; and/or a remaining lifetime of the local storage
the method further comprises making a comparison based on the amount of bandwidth which is currently available or is predicted to be available for writing data to and/or reading data from the local storage and the amount of bandwidth which is currently available or is predicted to be available for writing data to and/or reading data from the remote storage, and
how to write data to or read data from the local storage and/or the remote storage is determined based on the comparison.

14. The method of claim 13, wherein
making the comparison comprises comparing the amount of bandwidth which is currently available or is predicted to be available for writing data to and/or reading data from the local storage to the amount of bandwidth which is currently available or is predicted to be available for writing data to and/or reading data from the remote storage,
the method comprises:
determining a ratio value based on the comparison; and
writing a first portion of data to the local storage and a second portion of the data to the remote storage, and
each of the first portion and the second portion is determined based on the ratio value.

15. The method of claim 13, wherein
the amount of bandwidth which is currently available or is predicted to be available for writing data to and/or reading data from the local storage is a first amount of bandwidth,
the amount of bandwidth which is currently available or is predicted to be available for writing data to and/or reading data from the remote storage is a second amount of bandwidth, and
making the comparison comprises comparing the first amount of bandwidth per power/energy to the second amount of bandwidth per power/energy.

16. The method of claim 15, wherein
in case the difference between the first amount of bandwidth per energy and the second amount of bandwidth per power/energy is less than a threshold value, writing a first portion of data to the local storage and a second portion of the data to the remote storage.

17. A non-transitory computer readable storage medium storing a computer program comprising instructions which when executed by processing circuitry of a user equipment (UE) causes the UE to perform the method of claim 1.

18. (canceled)

19. A user equipment (UE), the UE comprising:
memory; and
processing circuitry, wherein the UE is configured to:
determine a condition of a local storage of the UE;
obtain first condition information that indicates a condition of a data path (132, 114, and 116) via which the UE is connected to a remote storage;
determine how to write data to or read data from the local storage and/or the remote storage based on the condition of the local storage and the condition of the data path; and
write data to and/or reading data from the local storage and/or the remote storage based on the determination, wherein
the data path comprises a wireless network.

20. The UE of claim 19, wherein
the condition of the local storage is determined based on:
an amount of a storage capacity of the local storage, which is currently available or is predicted to be available during a certain time interval;
an amount of bandwidth which is currently available or is predicted to be available for writing data to and/or reading data from the local storage;
an estimated or predicted latency of writing data to and/or reading data from the local storage;
an amount of energy required, used, or predicted to be used for writing data and/or reading data from the local storage; and/or
a remaining lifetime of the local storage.

21. (canceled)
